(19) United States
(12) Patent Application Publication
(10) Pub. No.: US 2008/0226971 A1
(43) Pub. Date: Sep. 18, 2008

(54) Hand-Held Power Tool

(75) Inventor: Wolfgang Stickel, Beuren (DE)

Correspondence Address: CENTRAL COAST PATENT AGENCY, INC, 3 HANGAR WAY SUITE D, WATSONVILLE, CA, 95076, US

(73) Assignee: METABOWERKE GMBH, Nuertingen (DE)

(21) Appl. No.: 12/067,431

(22) PCT Filed: Sep. 20, 2005
(86) PCT No.: PCT/EP2005/010111

§ 371 Date: Mar. 19, 2008

(51) Int. Cl. H01M 2/10; H01M 6/42

(52) U.S. Cl. 429/99; 429/159

(57) ABSTRACT

The invention relates to a hand-held power tool comprising a tool housing and an electric motor housed in the tool housing and a battery pack (30) for supplying the electric motor with electrical energy. The battery pack (30) can be detachably locked with the tool housing and comprises a battery housing (28) in which the battery cells (10) are received. The invention is characterized in that damping elements (26) are provided between the battery housing (28) and the battery cells (10) and decouple the battery cells (10) from the battery housing (28) in a vibration-damping manner.

The invention relates to a hand-held power tool comprising a tool housing and an electric motor housed in the housing for driving a tool as well as a battery pack for supplying the electric motor with electrical energy, where said battery pack can be detached and interlocked with the housing.

Hand-held power tools such as impact drills, power drills, power screwdrivers, etc. for the craftsman or the do-it-yourselfer are increasingly supplied as cordless tools because they provide greater flexibility during work and in particular independence of an existing electrical source, which allows in particular for carrying out work outdoors in many locations. Such cordless tools include a rechargeable battery in a battery housing that can be coupled with the tool housing of the hand-held power tool, where upon coupling of the two housings the motor is electrically connected to the battery pack and is supplied with electricity from it. To couple the two housings, the battery housing is typically provided with a protruding locking mechanism that is pushed into and engages in a complementing socket of the tool housing. The electrical contacts are often in the area of the locking device.

Hand-held power tools in general, but in particular tools for impact drilling, generate significant vibrations during operation. These vibrations are transferred via the tool housing and the locking points to the battery housing and from there to the battery cells that are present in the battery housing.

Such vibrations of the battery pack have an adverse effect on the service life of the battery pack, in particular the battery cells, and the electrical contacts; furthermore, because of the significant mass of the battery cells in the battery pack, there is also the risk of wear of the locking mechanism leading initially to a greater play of said mechanism, creating the appearance of poor quality. In the end, this can result in the inability of locking or in poor locking, in particular in impact drilling operations.

As a potential solution, DE 200 21 184 U1, for example, recommends to provide the battery pack with a device for holding electrically non-insulated battery cells, using first and second holding components that exhibit in a plane grid-like arranged, ring-shaped framing element, where said framing elements electrically insulate and space the battery cells against each other, and where the battery cells are positively held therein, such that a safeguard is provided against the vibration behavior as well. The disadvantage with such components is that they require a high degree of production accuracy in order to securely avoid a play between the holding elements and the battery cells.

Furthermore, a hand-held electrical power tool with a rechargeable battery pack is known from DE 103 18 947 A1, where a spring/dampening element is provided between the housing of the battery pack and the housing of the hand-held power tool to dampen the vibrations and to eliminate a play between the battery pack and the machine housing due to the locking mechanism.

It is the objective of the present invention to provide an alternative concept for preventing the transfer of the vibrations from a hand-held power tool to the battery cells in the battery pack.

The invention accomplishes this objective through a hand-held power tool with the features of claim 1, where a battery pack comprises a battery housing in which the battery cells are supported and where dampening elements are provided between the battery housing and the battery cells and decouple the battery cells from the battery housing with regard to the vibrations. Such a design has the advantage that the requirements for attaching the battery cells in the battery pack can be simple in order to reliably prevent a movement of said battery cells in the battery pack even during impact drilling operations. In this manner, permanent electrical contacting of the cells can be improved, and, in addition, a locking mechanism that is present between the housing of the battery pack and the tool housing and which, as a rule, positively engages the two can be under less strain than is often known from the state-of-the-art.

In particular, spring/dampening elements are considered for use as the dampening elements, whereby the dampening elements are in particular arranged between a so-called electronics cup, where the battery cells are positively attached and subsequently welded to it, and the battery housing. In particular, it can be provided that a unit of several battery cells is produced in advance, a so-called core pack, which is then connected in its entirety with the electronics cup. Arranged in the electronics cup is the electronics unit, in particular also including the charge level indicator, and is potted with the cup in advance to form one unit. Electrical contacting of the battery cells occurs by placing the battery cells of the core pack onto the electronics unit, whereby the battery cells can be switched alternatively in series or parallel.

Furthermore, a test interface can be provided, which is connected to the electronics unit and allows for a functionality test of the electronics after attaching the core pack, or the battery cells, respectively, before installing the battery housing.

Elements made of thermoplastic elastomers can be provided as the dampening elements, which can either be attached subsequently to the electronics cup or to the battery housing, or alternatively can be attached to one of these components during their manufacture. However, fundamentally other spring/dampening elements such as rubber springs, coil springs, etc., as well as all other dampening devices, can be used as well.

The spring and/or dampening elements can be employed such that they are oriented according to the main direction of the vibration in order to achieve the greatest possible vibration dampening effect. Alternatively, it is also possible to provide dampening elements for the various directions of the vibrations in order to achieve additional stabilization.

According to the invention, it is furthermore provided that the battery pack features terminals for the electrical connection to the electric motor, whereby the electrical terminals exhibit flexible areas for decoupling the battery pack from the tool housing. Because the tool housing positively engages with the battery housing, there is often the risk that the vibrations are transferred from one housing to the other at this location. To achieve vibration decoupling in addition to the vibration dampening of the battery cells in the battery pack, dampening and/or spring/dampening elements can also be provided between the two housings. In this case, it can be particularly advantageous to use thermoplastic elastomers for the elements as well, and in particular it can be provided to arrange the dampening elements in the recess in which the locking element of the battery pack engages because they are less susceptible to environmental influences at this location. However, as an alternative it may also be provided to design the locking component of the battery pack, which as a rule also includes the electrical connections, in a flexible manner or with flexible zones, respectively, such that the vibrations of the tool housing are compensated for by the flexibility. In addition, it can be provided that the electrical connections exhibit at least flexible zones that can follow along with the vibrations and in this manner prevent the electrical contacts from being affected or destroyed. The same applies to indicators or control elements at the battery housing, because they are directly coupled to the battery cells in the battery pack, while the elements themselves, however, are attached to the battery housing. The flexible zones ensure vibration decoupling here as well.

In particular, lithium cells that can be switched parallel or in series are considered for use as the battery cells. By switching two cells parallel, the output power is doubled, and lithium cells are less susceptible when switched parallel in contrast to conventional battery cells. In parallel switching, conventional battery cells have the disadvantage that the cells discharge differently when switched parallel, which may cause them to break down.

In the following, the invention shall be further explained using a drawing, where:

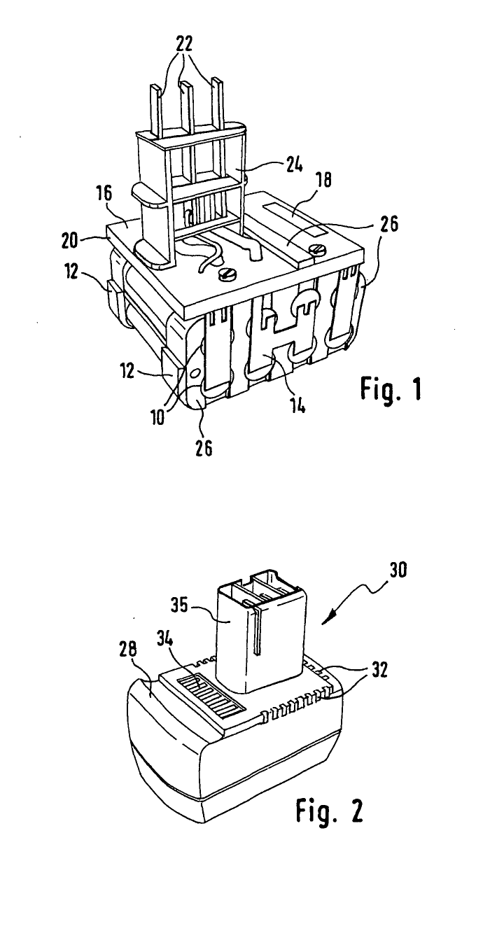

FIG. 1 shows a battery pack without a housing;

FIG. 2 shows a battery pack, and

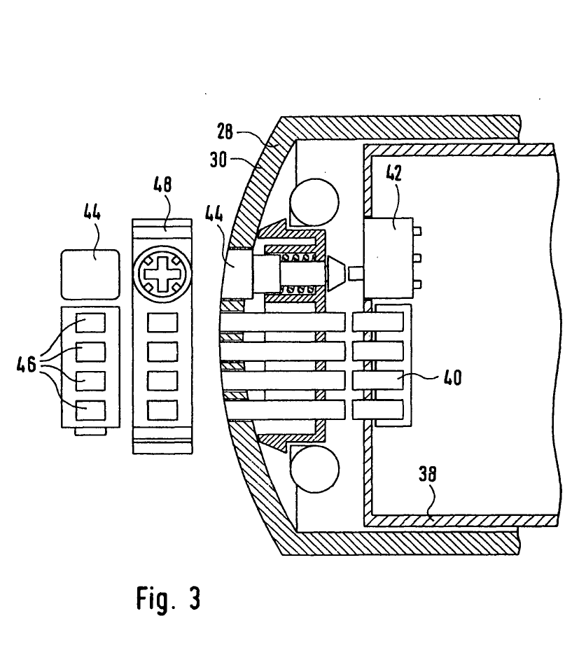

FIG. 3 is a sectional presentation of a battery pack in the area of the charge level indicator.

FIG. 1 shows a battery pack without a housing with a unit combining several battery cells, which are here provided with the reference character 10, a so-called core pack together with the associated electronics. The individual battery cells 10 are supported at a distance from each other using spacers 12, such that there is no contact between the individual battery cells 10, which could cause shorts. In the design at hand, eight battery cells are provided with two cells each switched parallel and four parallel-switched battery cell pairs being switched in series. By switching the lithium cells 10 used here in parallel, the output power can be doubled. Electrical contacting of the battery cells 10 is carried out via contact elements 14. The battery cells 10 are then positively attached to the electronics unit 16 via the holding device 12, and the cells are welded together. A test interface 18, which is later covered by a battery housing, is provided to test the unit after the assembly.

The electronics 16 for the core pack is embedded in a synthetic component 20, the so-called electronics cup, and thus protected from external influences.

A contact system 22 is provided to connect a battery pack with a battery-powered tool, with said contact system exhibiting three terminals as well as a digital data port. The contact system is guided in a flexible connection device 24, whereby vibration decoupling between a housing of the hand-held power tool and the battery pack is provided through the flexibility of the connection device, which is later covered by the housing of the battery pack and engages in a corresponding recess of the hand-held power tool.

In addition, dampening elements 26 are provided that provide vibration decoupling of the inner workings of the battery pack from the battery housing, as designated in FIG. 2 with the number 28. In particular, the dampening elements can be made of thermoplastic elastomers and can be attached at the holding device 12 as well as on the electronics unit 16.

FIG. 2 shows the battery pack, which in its entirety is designated with the number 30, with the housing 28, in which ventilation slots 32 are provided for air intake and 34 for the air outlet because the battery pack 30 is air-cooled to increase the service life of the battery cells 10. The contact system with the terminals 22 is also entirely enclosed in the housing 28 of the battery pack 30 with the housing 28 of the battery pack 30 ensuring a separation and mechanical protection of the individual terminals 22. For its use, the battery pack is inserted with the area 35 of the housing 28 into a corresponding receptacle of a hand-held power tool and engages there positively.

The provided dampening elements 26 serve the vibration decoupling of the battery cells 10 from the housing of the battery pack 28, and thus from a housing of the hand-held power tool that is operated with the battery pack 30. This, on the one hand, reduces the vibrations of the battery pack and thus the risk of damage of the locking system between the battery pack 30 and the hand-held power tool even during impact drilling, and on the other hand protects the cells 10 themselves.

FIG. 3 is a schematic presentation of a section of the battery pack 30 with the housing 28 and the core pack located in it with the so-called electronics cup 38, wherein connections 40 are provided for a charge level indicator as well as an element 42, which is controlled via a button 44. The button 44 and the charge level indicator 46 are attached via an interim element 48, which is positively locked to the housing 28 and which provides a flexible connection to the components 40 and 42. A total of four LEDs is provided for the charge level indicator, whereby no lit LED corresponds to a capacity range of 0 to 20%, one lit LED to a capacity range of 20 to 40%, two lit LEDs to a range of 40 to 60%, three lit LEDs to a range of 60 to 80%, and all lit LEDs to a capacity range of 80 to 100%.

With an appropriate design according to the invention and dampened support of the core pack and of the electronics with the battery housing 28, the service life of both the battery cells and the locking mechanism between a hand-held power tool and the battery pack can be improved, and in particular the impact-drilling strength of the tool can be ensured.

1. A hand-held power tool with a tool housing and an electric motor located in the tool housing as well as battery pack (30) for supplying the electric motor with electrical energy that can be detached and can interlock with the tool housing, where the battery pack (30) includes a battery housing (28) in which the battery cells (10) are supported, characterized in that dampening elements (26) are provided between the battery housing (28) and the battery cells (10) and decouple the battery cells (10) from the battery housing (28) with regard to vibration.

2. A hand-held power tool as set forth in claim 1, characterized in that several battery cells (10) are combined in one unit.

3. A hand-held power tool as set forth in claim 1, characterized in that the battery cells (10) are connected to an electronics unit (16).

4. A hand-held power tool as set forth in claim 1, characterized in that the battery pack (30) exhibits terminals (22) for the electrical connection to the electric motor, whereby the electrical terminals (22) exhibit flexible areas for decoupling the battery pack (30) from the tool housing.

5. A hand-held power tool as set forth in claim 1, characterized in that an indicator and/or control elements (44, 46) are provided at the battery housing (28), and are connected to the electronics of the battery pack (30) via flexible connectors and/or via dampening elements.

6. A hand-held power tool as set forth in claim 1, characterized in that the battery cells (10) are lithium cells.

7. A hand-held power tool as set forth in claim 2, characterized in that the battery cells (10) are connected to an electronics unit (16).

8. A hand-held power tool as set forth in claim 2, characterized in that the battery pack (30) exhibits terminals (22) for the electrical connection to the electric motor, whereby the electrical terminals (22) exhibit flexible areas for decoupling the battery pack (30) from the tool housing.

9. A hand-held power tool as set forth in claim 3, characterized in that the battery pack (30) exhibits terminals (22) for the electrical connection to the electric motor, whereby the electrical terminals (22) exhibit flexible areas for decoupling the battery pack (30) from the tool housing.

10. A hand-held power tool as set forth in claim 2, characterized in that an indicator and/or control elements (44, 46) are provided at the battery housing (28), and are connected to the electronics of the battery pack (30) via flexible connectors and/or via dampening elements.

11. A hand-held power tool as set forth in claim 3, characterized in that an indicator and/or control elements (44, 46) are provided at the battery housing (28), and are connected to the electronics of the battery pack (30) via flexible connectors and/or via dampening elements.

12. A hand-held power tool as set forth in claim 4, characterized in that an indicator and/or control elements (44, 46) are provided at the battery housing (28), and are connected to the electronics of the battery pack (30) via flexible connectors and/or via dampening elements.

13. A hand-held power tool as set forth in claim 2, characterized in that the battery cells (10) are lithium cells.

14. A hand-held power tool as set forth in claim 3, characterized in that the battery cells (10) are lithium cells.

15. A hand-held power tool as set forth in claim 4, characterized in that the battery cells (10) are lithium cells.

16. A hand-held power tool as set forth in claim 5, characterized in that the battery cells (10) are lithium cells.
